(19) United States
(12) Patent Application Publication
(10) Pub. No.: US 2017/0224028 A1
(43) Pub. Date: Aug. 10, 2017

(54) PORTABLE CHARGING APPARATUS AND PANTS THAT ALLOW CHARGING USING THE SAME

(71) Applicant: Myoung-Il KIM, Namyangju-si (KR)

(72) Inventor: Myoung-Il KIM, Namyangju-si (KR)

(21) Appl. No.: 15/063,912

(22) Filed: Mar. 8, 2016

(30) Foreign Application Priority Data
Feb. 5, 2016 (KR) 10-2016-0014563

(51) Int. Cl. A41D 1/00; A41D 27/08; A41D 1/06; H02J 7/00; A41D 27/20

(52) U.S. Cl. CPC A41D 1/005; H02J 7/0045; A41D 27/205; A41D 1/06; A41D 27/08

(57) ABSTRACT

Provided is a portable charging apparatus including: a housing case having a battery embedded therein; a battery charging connector pivotably accommodated in one side surface of the housing case, connected to an external power supply unit; a battery discharging connector accommodated in and detached from one side surface of the housing case, connected to the portable electronic device and allowing the portable electronic device; a connection cable accommodated in and detached from one side surface of the housing case, connecting the housing case and the battery discharging connector with a predetermined length and allowing the battery discharging connector to be connected to the portable electronic device; a front panel combined with a front surface of the housing case and protecting the housing case; and a rear panel combined with a rear surface of the housing case, protecting the housing case.

### CROSS-REFERENCE TO RELATED PATENT APPLICATION

This application claims the benefit of Korean Patent Application No. 10-2016-0014563, filed on Feb. 5, 2016, in the Korean Intellectual Property Office, the disclosure of which is incorporated herein in its entirety by reference.

### BACKGROUND OF THE INVENTION

1. Field of the Invention

The present invention relates to a portable charging apparatus and pants that allow charging using the portable charging apparatus, and more particularly, to a portable charging apparatus that allows a portable electronic device to be charged by the portable charging apparatus in a state in which the portable electronic device, such as a smartphone, is accommodated in a pocket of pants, after the portable charging apparatus is simply provided at the pants.

2. Description of the Related Art

Since, these days, owing to technology development in the field of wireless communication network and wireless Internet, an environment in which users can use the Internet anytime somewhere, has been widely spread, portable electronic devices that are easy to carry and capable of performing operation processing with high performance, such as smartphones or tablet personal computers (PCs), have been widely used.

Batteries used in these portable electronic devices have to be recharged or replaced when a predetermined amount of time elapses or a charged power supply is discharged. A power supply unit, such as a commercially available power supply or an auxiliary power supply, has to be used to recharge a battery.

However, since a power supply unit and a portable electronic device are connected to each other using an additional charging apparatus in one place, charging the battery using the above method requires much time and causes many inconveniences due to the existence of the additional charging apparatus and compatibility between an electronic device and the charging apparatus.

Thus, in order to solve the above problems, Korean Utility-model Registration No. 20-0291141 and Korean Patent Laid-open Publication No. 10-2012-42080 disclose a bag with a solar cell panel that converts solar thermal energy into electrical energy, the bag including a storage battery connected to the solar cell panel and storing the electrical energy supplied from the solar cell panel, a battery pack including an input/output terminal connected to the storage battery and supplying the electrical energy stored in the storage battery outward, and a connector connected to the input/output terminal and supplying the electrical energy to a portable electronic device.

However, in a conventional portable charging apparatus and a fashion product having the same, the solar cell panel that converts solar thermal energy into electrical energy is configured in the product. Thus, when the solar cell panel is configured in pants, a design of the pants is dependent on the solar cell panel and thus is not diverse. As a result, an esthetic appeal of the design is lowered, and explosion may occur due to an environment, such as exposure to the outside, strong shock or overcharge.

### SUMMARY OF THE INVENTION

The present invention provides a portable charging apparatus that allows a portable electronic device to be charged by the portable charging apparatus in a state in which the portable electronic device is accommodated in a pocket of pants, after the portable charging apparatus is simply held and provided at the pants so that safe and convenient charging can be performed without disturbing a design of the pants, and pants having the portable charging apparatus.

According to an aspect of the present invention, there is provided a portable charging apparatus including: a housing case having a battery embedded therein; a battery charging connector configured to be pivotally accommodated in one side surface of the housing case, connected to an external power supply unit and allow the battery to be charged; a battery discharging connector accommodated in and detached from one side surface of the housing case, connected to the portable electronic device when the battery discharging connector is detached from the housing case and allowing the portable electronic device to be charged through power of the battery; a connection cable accommodated in and detached from one side surface of the housing case, connecting the housing case and the battery discharging connector with a predetermined length and allowing the battery discharging connector to be connected to the portable electronic device when the connection cable is detached from the housing case; a front panel combined with a front surface of the housing case and protecting the housing case from external shock; and a rear panel combined with a rear surface of the housing case, protecting the housing case from external shock and including a clip attached to/detached from a patch (or label) of the pants.

According to another aspect of the present invention, there are provided pants including: the portable charging apparatus; a pocket having a space in which a portable electronic device is accommodated; and a patch (or label) that is located at an upper portion of the pocket, allows the clip formed at the rear panel of the portable charging apparatus to be fit into the patch when the portable electronic device is accommodated in the accommodation space of the pocket so that the portable electronic device is charged through the battery discharging connector of the portable charging apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a portable charging apparatus according to an exemplary embodiment of the present invention;

FIG. 2 is an exploded perspective view of the portable charging apparatus of FIG. 1;

FIG. 3 is a view illustrating a state in which the portable charging apparatus of FIG. 1 is held and configured at pants; and

FIG. 4 is a view illustrating a portable electronic device accommodated in a pocket of pants in a state in which the portable electronic device is connected to the portable charging apparatus of FIG. 3 to be chargeable.

### DETAILED DESCRIPTION OF THE INVENTION

Hereinafter, an exemplary embodiment of the present invention will be described in detail with reference to the attached drawings.

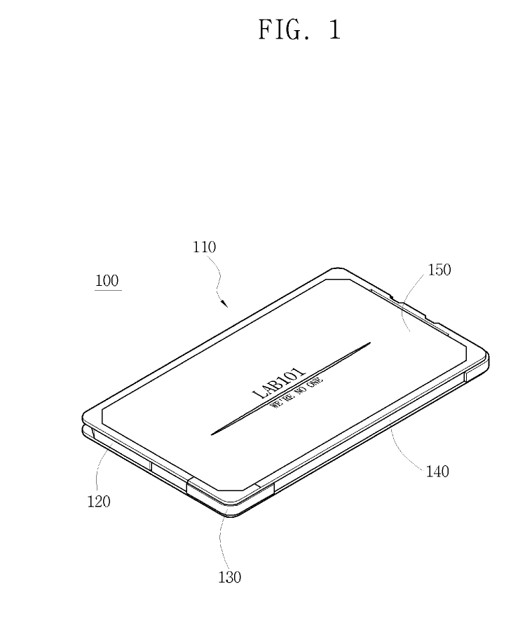

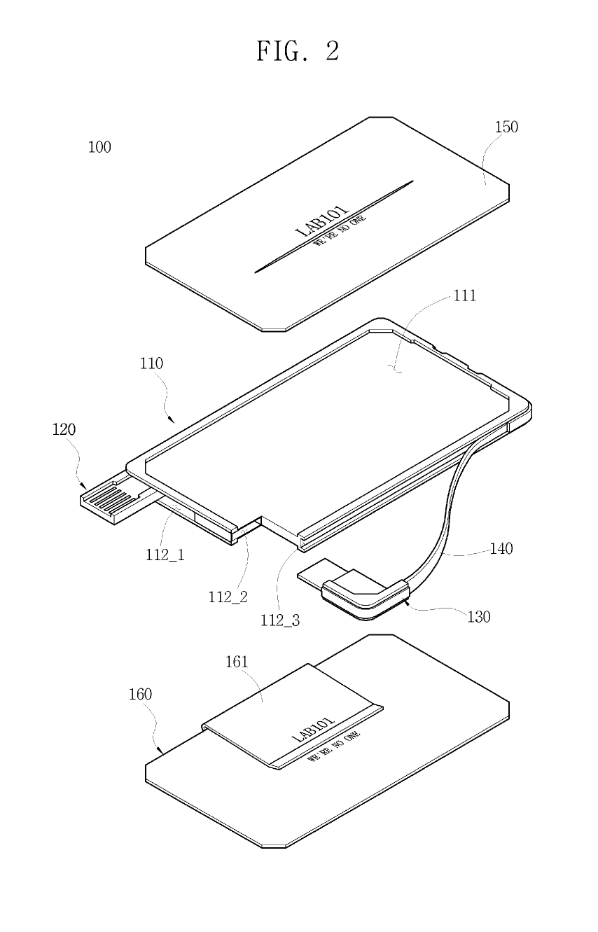

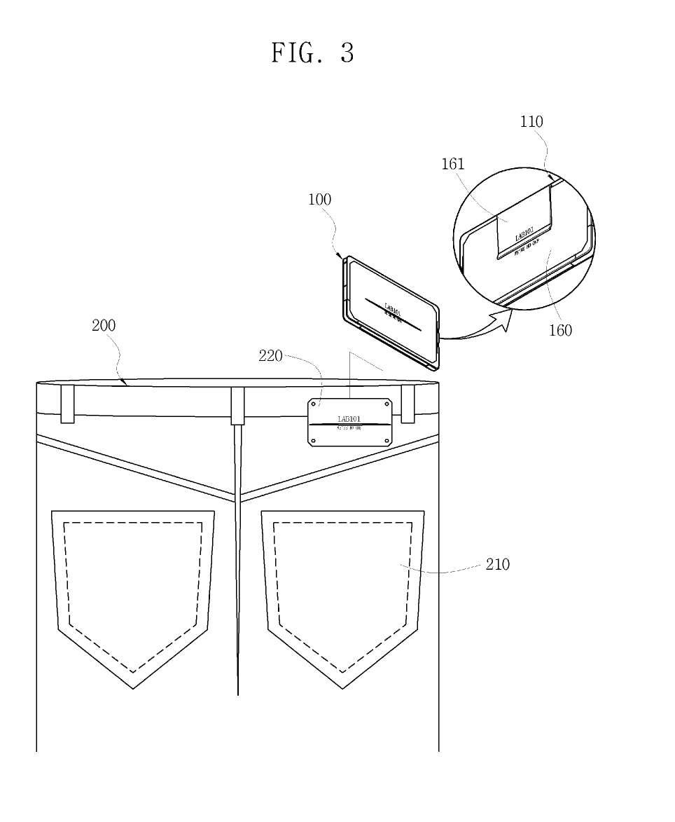

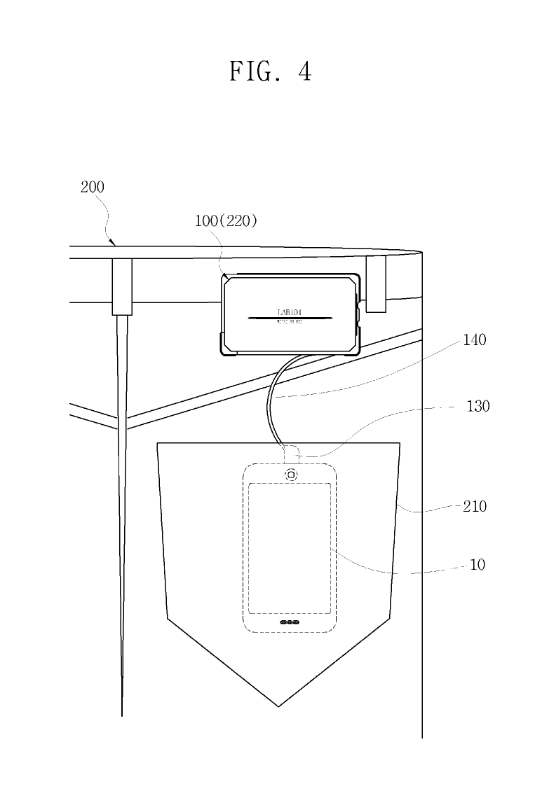

FIG. 1 is a perspective view of a portable charging apparatus according to an exemplary embodiment of the present invention, FIG. 2 is an exploded perspective view of the portable charging apparatus of FIG. 1, FIG. 3 is a view illustrating a state in which the portable charging apparatus of FIG. 1 is held and configured at pants, and FIG. 4 is a view illustrating a portable electronic device accommodated in a pocket of pants in a state in which the portable electronic device is connected to the portable charging apparatus of FIG. 3 to be chargeable.

First, as illustrated in FIGS. 1 through 4, a portable charging apparatus 100 according to an exemplary embodiment of the present invention includes: a housing case 110 having a battery (not shown) embedded therein; a battery charging connector 120 configured to be pivotally accommodated in one side surface of the housing case 110, connected to an external power supply unit and allowing the battery to be charged; a battery discharging connector 130 accommodated in and detached from one side surface of the housing case 110, connected to a portable electronic device 10 when the battery discharging connector 130 is detached from the housing case 110 and allowing the portable electronic device 10 to be charged by power of the battery; a connection cable 140 accommodated in and detached from one side surface of the housing case 110, connecting the housing case 110 and the battery discharging connector 130 with a predetermined length and allowing the battery discharging connector 130 to be connected to the portable electronic device 10 when the connection cable 140 is detached from the housing case 110; a front panel 150 that is combined with a front surface of the housing case 110 and protects the housing case 110 from external shock; and a rear panel 160 that is combined with a rear surface of the housing case 110, protects the housing case 110 from external shock and includes a clip 161 attached to/detached from a patch (or label) 220 of pants 120.

Here, in the portable charging apparatus 100 according to the present invention, preferably, an on/off switch (not shown) that allows charging of the portable electronic device 10 using the battery discharging connector 130 and a light emitting diode (LED) lamp (without a reference numeral) that allows an operating state of the on/off switch to be checked by user's naked eyes are configured in predetermined positions of the housing case 110.

The housing case 110 that is a protection unit having a predetermined size and a predetermined thickness and protecting a battery embedded therein, more preferably, has the form of a rectangular panel having a small thickness and includes coupling depression 111 that correspond to the thickness and shape of each of the front panel 150 and the rear panel 160 and are formed in front and rear surfaces of the housing case 110 so that the front panel 150 and the rear panel 160 can be combined with each other without any step height through the coupling depression 111, and accommodation grooves 112_1,112_2,112_3 through which the battery charging connector 120, the battery discharging connector 130, and the connection cable 140 are respectively accommodated in the housing case 110 and which are formed in side surfaces of the housing case 110 that improve the beauty.

Here, the battery is a well-known configuration and thus, a detailed description thereof will be omitted.

The battery charging connector 120 that is a connector unit pivotally configured in one side surface of the housing case 110, connected to an external commercially available power supply or power supply unit and allows the battery to be charged, preferably, is a universal serial bus (USB) connector that is pivotally configured to be accommodated in a first accommodation groove 112_1 formed in a side surface of the housing case 110 so that, when the battery charging connector 120 rotates in a predetermined direction, the battery charging connector 120 is accommodated in an accommodation space and when the battery charging connector 120 rotates in an opposite direction, the battery charging connector 120 is connected to the external power supply unit.

Here, the configuration of the USB connector and the configuration in which the USB connector is connected to the battery to be electrically chargeable are well-known and thus, a detailed description thereof will be omitted.

The battery discharging connector 130 that is a connector unit configured at one side surface of the housing case 110, connected to the portable electronic device 10 and allows charging through power of the battery, preferably, is a 5 pin or 8 pin adapter that is configured to be inserted into and detached from a second accommodation groove 112_2 formed when the front panel 150 and the rear panel 160 are configured in one side surface of the housing case 110 so that, when the battery discharging connector 130 is inserted into the second accommodation groove 112_2, the battery discharging connector 130 is accommodated in the accommodation space, and when the battery discharging connector 130 is detached from the second accommodation groove 112_2, the battery discharging connector 130 is fully separated from the housing case 110 and is inserted into a charging port of the portable electronic device 10.

Here, the configuration of the adapter and the configuration in which the adapter is connected to the battery to be electrically dischargeable through the connection cable are well-known and thus, a detailed description thereof will be omitted.

In the connection cable 140 that is a connection unit allowing the battery discharging connector 130 to be separated from one side surface of the housing case 110 to have a predetermined length and the battery discharging connector 130 to be connected to the portable electronic device 10 accommodated in a pocket 210 of the pants 200 when the housing case 110 is held and configured in the pants 200, one end of the connection cable 140 is connected to and fixed to the battery in the housing case 110, and the other end of the connection cable 140 is connected to and fixed to the battery discharging connector 130, and the connection cable 140 is configured to be inserted into and detached from a third accommodation groove 112_3 formed in a side surface of the housing case 110 so that the connection cable 140 can be maintained to be accommodated in the accommodation space when being inserted into the third accommodation groove 112_3 and to be spaced a length of accommodation apart from the third accommodation groove 112_3 when being detached from the third accommodation groove 112_3.

Here, preferably, the connection cable 140 has a covering that is flexible and has a polygonal shape. Thus, when the connection cable 140 is accommodated in the third accommodation groove 112_3, the connection cable 140 is not well detached from the third accommodation groove 112_3, and when a weight of the portable electronic device 10 accommodated in the pocket 210 of the pants 200 is transferred to the connection cable 140 (for example, when the portable electronic device 10 is detached from the pocket 210 when a user moves while the portable electronic device 10 is in a charging state), a predetermined shock-absorbing function is provided so that the connection cable 140 cannot be cut.

In addition, preferably, the connection cable 140 has a length corresponding to the housing case 110 in a lengthwise direction. Thus, the connection cable 140 allows accommodation and simultaneously, when accommodation of the connection cable 140 is released, allows the battery discharging connector 130 to be separated from the housing case 110 to a predetermined length, i.e., up to the pocket 210, thereby allowing combination with the portable electronic device 10 accommodated in the pocket 210.

The front panel 150 that is a protection member combined with the front surface of the housing case 110, protecting the housing case 110 from external shock and providing an advertising function through a predetermined advertising copy, is a thin plate that is fixed to and combined with the housing case 110 without any step height in a state in which the front panel 150 is seated in each coupling depression 111 formed in the front surface of the housing case 110.

Here, preferably, a predetermined advertising design or advertising text is made by laser processing or boring so that the front panel 150 can be provided with an advertising effect.

The rear panel 160 that is a protection and holding member combined with the rear surface of the housing case 110, protecting the housing case 110 from external shock and attached to the patch (or label) 220 of the pants 200 to be detachable so that the housing case 110 is held and carried in the pants 200, preferably, is a thin plate that is fixed to and combined with the housing case 110 without any step height in a state in which the rear panel 160 is seated in each coupling depression 111 formed in the rear surface of the housing case 110.

Here, the clip 161 of the rear panel 160 combined fit into the patch 220 of the pants 200 is bent and is formed as a one body with the rear panel 160. Thus, the housing case 110 can be held and carried in the pants 200.

Thus, according to the portable charging apparatus 100 described above, the portable charging apparatus 100 can be configured to be held in the patch 220 of the pants 200 so that safe and convenient charging can be performed with an inherent design of the pants 200.

In addition, when the portable charging apparatus 100 is held in the patch 220 of the pants 200, a function as an accessory that improves an esthetic appeal of the pants 200 through the inherent design can be provided.

In addition, through a structure in which the portable charging apparatus 100 is held in the pants 200, charging of the portable electronic device 10 can be performed even when the user is moving.

Meanwhile, as illustrated in FIGS. 1 through 4, the pants 200 that allows charging using the portable charging apparatus 100 according to an exemplary embodiment of the present invention includes the pocket 210 having a space in which the portable electronic device 10 is accommodated, and the patch (or label) 220 that is located at an upper portion of the pocket 210, allows the clip 161 formed at the rear panel 160 of the portable charging apparatus 100 to be fit into the patch 220 when the portable electronic device 10 is accommodated in the accommodation space so that the portable electronic device 10 is charged through the battery discharging connector 130 of the portable charging apparatus 100.

Here, the pants 200 may include all well-known pants, such as jeans, cotton pants or short pants including at least one pocket 210 and the patch 220 located at the upper portion of the pocket 210. Thus, a detailed description thereof will be omitted.

In addition, a distance from an upper open end of the pocket 210 to a lower end of the patch 220 may be shorter than a length of the connection cable 140 of the portable charging apparatus 100. Thus, a charging port of the portable electronic device 10 accommodated in the pocket 210 and the battery discharging connector 130 connected to an end of the connection cable 140 can be easily combined with each other.

In addition, preferably, a predetermined advertising design or advertising text is made by laser processing or boring so that the patch 220 can be provided with an advertising effect.

Thus, according to the pants 200 having the portable charging apparatus 100 described above, the portable electronic device 10 is electrically combined with the portable charging apparatus 100 in a state in which the portable electronic device 10 is accommodated in the pocket 210 of the pants 200 and the portable charging apparatus 100 is held in the patch 220, so that charging of the portable electronic device 10 can be performed using the portable charging apparatus 100.

Meanwhile, a magnetic member is configured at at least one of an inner side surface of the patch 220 and an inner side surface of the clip 161 so that a combination state of the portable charging apparatus 100 and the pants 200 through magnetism can be better established. Thus, due to an external force generated when the user moves, the portable charging apparatus 100 cannot be easily separated from the pants 200.

In addition, preferably, the portable charging apparatus 100 and the patch 220 according to the present invention include a metallic material for improved durability.

According to the present invention, in a state in which a portable electronic device is accommodated in a pocket of pants after a portable charging apparatus is simply held and provided at the pants, the portable electronic device can be charged by the portable charging apparatus so that safe and convenient charging can be performed without disturbing a design of the pants.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A portable charging apparatus comprising:
a housing case having a battery embedded therein;
a battery charging connector configured to be pivotally accommodated in one side surface of the housing case, connected to an external power supply unit and allow the battery to be charged;
a battery discharging connector accommodated in and detached from one side surface of the housing case, connected to the portable electronic device when the battery discharging connector is detached from the housing case and allowing the portable electronic device to be charged through power of the battery;
a connection cable accommodated in and detached from one side surface of the housing case, connecting the housing case and the battery discharging connector with a predetermined length and allowing the battery discharging connector to be connected to the portable electronic device when the connection cable is detached from the housing case;
a front panel combined with a front surface of the housing case and protecting the housing case from external shock; and
a rear panel combined with a rear surface of the housing case, protecting the housing case from external shock and comprising a clip attached to/detached from a patch (or label) of the pants.

2. The portable charging apparatus of claim 1, wherein the housing case has a form of a rectangular panel having a small thickness, and coupling depressions are formed in the front surface and the rear surface of the housing case so that the front panel and the rear panel are combined without any step height, and accommodation grooves (a first accommodation groove, a second accommodation groove, a third accommodation groove) through which the battery charging connector, the battery discharging connector, and the connection cable are respectively accommodated in the housing case, are formed in side surfaces of the housing case.

3. The portable charging apparatus of claim 2, wherein one end of the connection cable is connected to and fixed to the battery in the housing case, and the other end of the connection cable is connected to and fixed to the battery discharging connector, and the connection cable is configured to be inserted into and detached from the second accommodation groove formed in a side surface of the housing case so that the connection cable is maintained to be accommodated in the accommodation space when being inserted into the second accommodation groove and to be spaced a length of accommodation apart from the second accommodation groove when being detached from the second accommodation groove.

4. The portable charging apparatus of claim 3, wherein the connection cable has a covering that is flexible and has a polygonal shape.

5. The portable charging apparatus of claim 2, wherein the clip of the rear panel combined fit into the patch of the pants is bent and is formed as a one body with the rear panel.

6. Pants comprising:
a portable charging apparatus of claim 1;
a pocket having a space in which a portable electronic device is accommodated; and
a patch (or label) that is located at an upper portion of the pocket, allows the clip formed at the rear panel of the portable charging apparatus to be fit into the patch when the portable electronic device is accommodated in the accommodation space of the pocket so that the portable electronic device is charged through the battery discharging connector of the portable charging apparatus.

7. The pants of claim 6, wherein a distance from an upper open end of the pocket to a lower end of the patch is shorter than a length of the connection cable of the portable charging apparatus.

8. Pants comprising:
a portable charging apparatus of claim 2;
a pocket having a space in which a portable electronic device is accommodated; and
a patch (or label) that is located at an upper portion of the pocket, allows the clip formed at the rear panel of the portable charging apparatus to be fit into the patch when the portable electronic device is accommodated in the accommodation space of the pocket so that the portable electronic device is charged through the battery discharging connector of the portable charging apparatus.

9. The pants of claim 8, wherein a distance from an upper open end of the pocket to a lower end of the patch is shorter than a length of the connection cable of the portable charging apparatus.

10. Pants comprising:
a portable charging apparatus of claim 3;
a pocket having a space in which a portable electronic device is accommodated; and
a patch (or label) that is located at an upper portion of the pocket, allows the clip formed at the rear panel of the portable charging apparatus to be fit into the patch when the portable electronic device is accommodated in the accommodation space of the pocket so that the portable electronic device is charged through the battery discharging connector of the portable charging apparatus.

11. The pants of claim 10, wherein a distance from an upper open end of the pocket to a lower end of the patch is shorter than a length of the connection cable of the portable charging apparatus.

12. Pants comprising:
a portable charging apparatus of claim 4;
a pocket having a space in which a portable electronic device is accommodated; and
a patch (or label) that is located at an upper portion of the pocket, allows the clip formed at the rear panel of the portable charging apparatus to be fit into the patch when the portable electronic device is accommodated in the accommodation space of the pocket so that the portable electronic device is charged through the battery discharging connector of the portable charging apparatus.

13. The pants of claim 12, wherein a distance from an upper open end of the pocket to a lower end of the patch is shorter than a length of the connection cable of the portable charging apparatus.

14. Pants comprising:
a portable charging apparatus of claim 5;
a pocket having a space in which a portable electronic device is accommodated; and
a patch (or label) that is located at an upper portion of the pocket, allows the clip formed at the rear panel of the portable charging apparatus to be fit into the patch when the portable electronic device is accommodated in the accommodation space of the pocket so that the portable electronic device is charged through the battery discharging connector of the portable charging apparatus.

15. The pants of claim 14, wherein a distance from an upper open end of the pocket to a lower end of the patch is shorter than a length of the connection cable of the portable charging apparatus.
